(19) United States
(12) Patent Application Publication
(10) Pub. No.: US 2025/0319638 A1
(43) Pub. Date: Oct. 16, 2025

(54) RESIN MOLDING APPARATUS AND METHOD FOR PRODUCING RESIN MOLDED PRODUCT

(71) Applicant: TOWA CORPORATION, Kyoto (JP)

(72) Inventors: Mamoru SUNADA, Kyoto (JP); Kosuke HAYASHI, Kyoto (JP); Yohei ONISHI, Kyoto (JP); Ken MORITA, Kyoto (JP)

(21) Appl. No.: 18/867,859

(22) PCT Filed: Jan. 11, 2023
(86) PCT No.: PCT/JP2023/000364

§ 371 Date: Nov. 21, 2024

(30) Foreign Application Priority Data
May 27, 2022 (JP) 2022-086938

(51) Int. Cl. B29C 43/34; B29C 33/68; B29C 43/18

(52) U.S. Cl. CPC B29C 43/34; B29C 33/68; B29C 43/18; B29C 2043/3427; B29C 2043/3494

(57) ABSTRACT

A resin molding apparatus includes: a resin supply mechanism configured to supply powder resin onto at least one object to be supplied; a mold die including: an upper die; and a lower die facing the upper die, the mold die being configured to receive the powder resin between the upper die and the lower die; and a mold clamp mechanism configured to clamp the mold die for compression molding. The resin supply mechanism includes: a rotor in a shape of a circular column with an outer surface having a plurality of depressions, the rotor being configured to rotate about an axis; a resin supply section configured to store the powder resin and having an opening for letting the powder resin drop freely onto the rotor; and a spatula-shaped member having a first end in contact with the outer surface of the rotor.

### TECHNICAL FIELD

This disclosure relates to a resin molding apparatus and a method for producing a resin molded product.

### BACKGROUND ART

Substrates with semiconductor chips mounted thereon, for example, are typically sealed up in resin for use as electronic parts. A known resin molding apparatus includes a resin supply mechanism configured to supply powder resin (see, for instance, Patent Literature 1).

Patent Literature 1 discloses a resin molding apparatus including a resin supply mechanism (“resin material supply device” in Patent Literature 1) configured to supply powder resin (“resin material” in Patent Literature 1) onto an object to be supplied (“resin material transfer tray” in Patent Literature 1) from a resin material supply opening in an end of a trough. Specifically, the resin supply mechanism vibrates the trough to let powder resin drop from the resin material supply opening to supply powder resin onto an object to be supplied in a fixed amount per unit time. This operation involves a relative movement of an object to be supplied and the resin material supply opening such that the object to be supplied returns to the supply start position without passing two or more times through the same relative position of the object to be supplied and the resin material supply opening.

### CITATION LIST

### Patent Literature

Patent Literature 1: Japanese Unexamined Patent Application Publication, Tokukai, No. 2018-65335

### SUMMARY OF INVENTION

### Technical Problem

Accurately producing a resin molded product requires accurately supplying powder resin onto an object to be supplied. This leads to powder resin being supplied from the resin material supply opening in a small amount per unit time. Further, the resin material supply opening disclosed in Patent Literature 1 has a small area as compared to an object to be supplied, meaning that the resin supply mechanism requires a long time to supply powder resin onto the entire object to be supplied. The resin supply mechanism requires a longer time if the object to be supplied is large for its relative movement.

The above circumstances have led to a demand for a resin molding apparatus and a method for producing a resin molded product each of which is capable of supplying powder resin with continued accuracy and in a large amount per unit time to shorten the supply time.

### Solution to Problem

A resin molding apparatus according to this disclosure characteristically includes: a resin supply mechanism configured to supply powder resin onto at least one object to be supplied; a mold die including: an upper die; and a lower die facing the upper die, the mold die being configured to receive the powder resin between the upper die and the lower die; and a mold clamp mechanism configured to clamp the mold die for compression molding, the resin supply mechanism including: a rotor in a shape of a circular column with an outer surface having a plurality of depressions, the rotor being configured to rotate about an axis; a resin supply section configured to store the powder resin and having an opening for letting the powder resin drop freely onto the rotor; and a spatula-shaped member having a first end in contact with the outer surface of the rotor.

A method according to this disclosure for producing a resin molded product characteristically is a method for producing a resin molded product with use of the above resin molding apparatus, the method including: supplying the powder resin onto the at least one object to be supplied with use of the resin supply mechanism; and supplying a substrate to be molded and the at least one object to be supplied onto the mold die and clamping the mold die with use of the mold clamp mechanism to produce a resin molded product.

### Advantageous Effects

This disclosure provides a resin molding apparatus and a method for producing a resin molded product each of which is capable of supplying powder resin with continued accuracy and in a large amount per unit time to shorten the supply time.

### BRIEF DESCRIPTION OF DRAWINGS

FIG. 1 is a diagram schematically illustrating a resin molding apparatus as the present embodiment.

FIG. 2 is a diagram schematically illustrating a mold clamp mechanism of a resin molding apparatus.

FIG. 3 is a diagram schematically illustrating a resin supply mechanism for a first embodiment.

FIG. 4 is a diagram schematically illustrating a resin supply mechanism as viewed in an X direction.

FIG. 5 is a diagram illustrating a variation of a rotor.

FIG. 6 is a diagram illustrating a variation of a rotor.

FIG. 7 is a diagram illustrating a variation of a rotor.

FIG. 8 is a diagram illustrating a variation of a rotor.

FIG. 9 is a diagram illustrating a variation of a rotor.

FIG. 10 is a diagram illustrating a scraper as being lifted by a coarse particle.

FIG. 11 is a diagram illustrating a variation of a scraper.

FIG. 12 is a diagram schematically illustrating a resin supply mechanism for a second embodiment.

FIG. 13 is a diagram schematically illustrating a first moving mechanism for the second embodiment.

FIG. 14 shows diagrams illustrating a procedure of weighing powder resin.

FIG. 15 shows diagrams illustrating a procedure of weighing powder resin.

FIG. 16 is a diagram schematically illustrating a first moving mechanism and second moving mechanism for a third embodiment.

FIG. 17 is a diagram schematically illustrating a resin supply mechanism for a fourth embodiment.

FIG. 18 is a plan view of a resin holding mechanism.

FIG. 19 is a vertical cross-sectional view of a resin holding mechanism.

### DESCRIPTION OF EMBODIMENTS

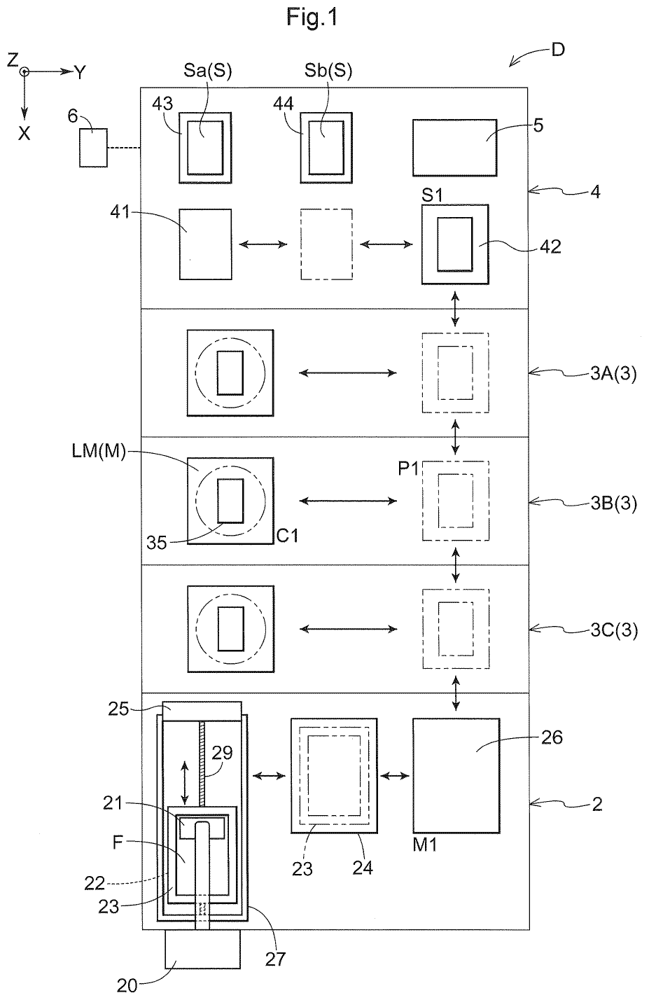

The description below deals with a resin molding apparatus and a method for producing a resin molded product as embodiments of this disclosure with reference to drawings. The embodiments described involve, as an example resin molding apparatus, a resin molding apparatus D including a resin supply module 2 as illustrated in FIG. 1. This disclosure is, however, not limited to the embodiments below, and may be altered variously as long as such alteration falls within the scope of this disclosure.

### [Apparatus Configuration]

Substrates with semiconductor chips mounted thereon, for example, are sealed up in resin for use as electronic parts. Objects to be molded are sealed up in resin by, for example, a compression method (compression molding) or transfer method. An example compression method is a resin sealing method that includes supplying powder resin onto a release film, placing the release film onto a lower die of a mold die, melting the powder resin on the release film into molten resin, and immersing an object to be molded into the molten resin for resin molding. The resin molding apparatus D as the present embodiment uses the compression method. The resin supply module 2 is configured to supply powder resin onto a release film F (which is an example of the “object to be supplied”). The description below is based on the premise that the object to be supplied (onto which the resin supply module 2 supplies powder resin) is a release film F and that the object to be molded is, as an example, a substrate S with semiconductor chips (hereinafter referred to also as “chips”) mounted thereon. Further, the gravitational direction corresponds to the downward direction, whereas the direction opposite to the gravitational direction corresponds to the upward direction. FIG. 1 shows a Z direction as an up-down direction. The description below will deal with a resin supply module 2, compression-molding modules 3, and a substrate supply/container module 4 arranged in an X direction. The direction perpendicular to the X and Z directions (that is, the depth direction of each module) is a Y direction. Example electronic elements include resistor elements and capacitor elements other than semiconductor chips. The term “powder resin” covers not only powder resin, but also particulate resin with particle sizes larger than those of powder resin and granular resin with particle sizes larger than those of particulate resin. The powder resin is solid at normal temperature, and may be a thermoplastic or thermosetting resin. The powder resin for the present embodiment is preferably a thermosetting resin.

The resin molding apparatus D illustrated in FIG. 1 includes as its elements a substrate supply/container module 4, three compression-molding modules 3 (compression-molding modules 3A, 3B, and 3C for discrimination), and a resin supply module 2. The substrate supply/container module 4, the compression-molding modules 3A, 3B, and 3C, and the resin supply module 2 are attachable to and detachable from one another and are replaceable. While the present embodiment includes three compression-molding modules 3, the number of compression-molding modules 3 may alternatively be one, two, or four or more.

The substrate supply/container module 4 includes a first container section 43, a second container section 44, a substrate placement section 41, and a substrate loader 42. The first container section 43 is configured to contain resin-sealing target substrates Sa as substrates provided with chips mounted thereon and not having been sealed up in resin. A resin-sealing target substrate Sa is a form of substrate S, and is an example of the “substrate to be molded”. The second container section 44 is configured to contain resin-sealed substrates Sb as substrates having been sealed up in resin. A resin-sealed substrate Sb is a form of substrate S, and is an example of the “resin molded product”. The substrate placement section 41 is for use to transfer resin-sealing target substrates Sa and resin-sealed substrates Sb. The substrate loader 42 is configured to convey resin-sealing target substrates Sa and resin-sealed substrates Sb. The substrate placement section 41 is movable along the Y direction in the substrate supply/container module 4. The substrate loader 42 is movable along the X and Y directions in each of the substrate supply/container module 4 and the compression-molding modules 3. The substrate loader 42 is configured to be on standby and not in operation at a predetermined position S1.

The substrate supply/container module 4 further includes a check mechanism (not illustrated in the drawings) configured to check in which area chips are disposed on a resin-sealing target substrate Sa as an object to be molded at the compression-molding modules 3. The check mechanism causes a laser displacement gauge to scan the surface of a resin-sealing target substrate Sa to check whether chips are actually disposed in the chip area that the check mechanism is intended to check, and thereby stores information on the area in which chips are disposed and the area in which no chips are disposed. The check mechanism may alternatively cause, for example, a visible-light camera to capture an image of the surface of a resin-sealing target substrate Sa and check on the basis of the captured image whether chips are disposed in the intended area on the resin-sealing target substrate Sa.

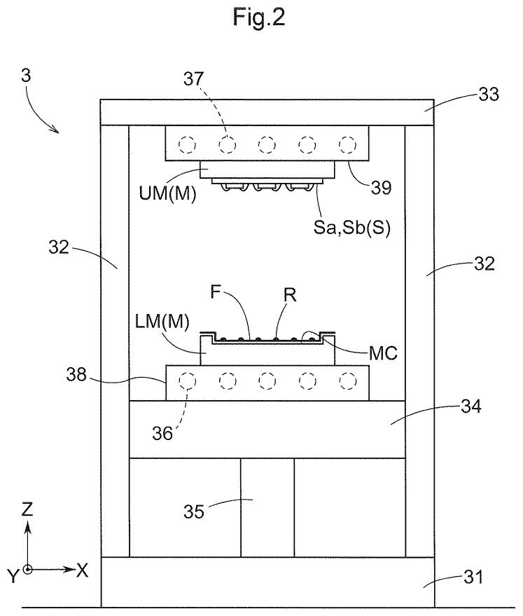

The compression-molding modules 3 each include a lower die LM configured to be lifted and lowered and an upper die UM facing the lower die LM (see FIG. 2). The upper die UM and the lower die LM constitute a mold die M. The compression-molding modules 3 each include a mold clamp mechanism 35 (see the circular portion indicated with a double-dashed chain line in FIG. 1) configured to clamp and open the upper die UM and the lower die LM. The lower die LM has a lower-die cavity MC configured to receive a release film F and powder resin R (see FIG. 2). The lower die LM and the upper die UM are movable relative to each other to be clamped and opened.

The resin supply module 2 includes an X-Y table, a release film supply mechanism 25, a cleaning mechanism 24, a resin loader 26, a resin conveyor mechanism 20, and a resin supply mechanism 21. The X-Y table includes a base 27, a resin scattering table 22 on the base 27, and a ball screw 29. The release film supply mechanism 25 is configured to supply a release film F onto the resin scattering table 22. The cleaning mechanism 24 is configured to clean the lower and inner surfaces of a frame 23 (which is an example of the “object to be supplied”). The resin loader 26 is configured to convey a frame 23. The resin conveyor mechanism 20 is configured to supply powder resin onto a release film F in a frame 23. The resin scattering table 22 is movable along the X and Y directions in the resin supply module 2. The resin loader 26 is movable along the X and Y directions in each of the resin supply module 2 and the compression-molding modules 3. The resin loader 26 is configured to be on standby and not in operation at a predetermined position M1.

The resin molding apparatus D includes a control section 5 including programs as software for controlling how the resin molding apparatus D is operated. The programs are stored on hardware such as a hard disc drive (HDD) or a memory, and are executed by a processor of a computer such as a central processing unit (CPU) or an application-specific integrated circuit (ASIC). The control section 5 for the present embodiment is configured to control the resin supply mechanism 21 of the resin supply module 2 for supplying powder resin onto a release film F in an amount (weight) with increased accuracy. The resin molding apparatus D includes a notification section 6 including, for example, a display and/or a warning lamp disposed in front of the substrate supply/container module 4 and configured to notify the operator about how the resin molding apparatus D is operated.

### [Configuration of Mold Die]

As illustrated in FIG. 2, each compression-molding module 3 for the present embodiment includes a pressed frame including a lower fixed plate 31, an upper fixed plate 33, and flat plate-shaped members 32 facing each other and integrating the lower fixed plate 31 with the upper fixed plate 33. The lower fixed plate 31 and the upper fixed plate 33 may be coupled to each other with use of four tie bars (columnar members) instead of the flat plate-shaped members 32. The compression-molding module 3 includes a movable platen 34 disposed between the lower fixed plate 31 and the upper fixed plate 33 and movable in the up-down direction along the flat plate-shaped members 32. The mold clamp mechanism 35 is disposed on the lower fixed plate 31 and configured to move the movable platen 34 upward and downward with use of, for example, a ball screw. The mold clamp mechanism 35 is capable of moving the movable platen 34 upward to clamp the mold die M and downward to open the mold die M. The mold clamp mechanism 35 may be driven by any driving source, for example, an electric motor such as a servomotor (not illustrated in the drawings).

The mold die M includes an upper die UM and a lower die LM made of, for example, metal and facing each other. The compression-molding module 3 includes, on the lower surface of the upper fixed plate 33, an upper-mold holder 39 including an upper heater 37 and having a lower surface to which the upper die UM is attached. The upper die UM includes, on its lower surface, an upper-die substrate attachment section (not illustrated in the drawings) to which is attachable a substrate S provided with, for example, chips mounted thereon (that is, a resin-sealing target substrate Sa). The compression-molding module 3 includes, on the upper surface of the movable platen 34, a lower-die holder 38 including a lower heater 36 and having an upper surface on which the lower die LM is disposed. The lower die LM has a lower-die cavity MC, into which a release film F is sucked by a suction mechanism and in which the release film F is held. This allows powder resin R supplied onto the release film F by the resin supply mechanism 21 to be provided in the lower-die cavity MC. The compression-molding module 3 causes the mold clamp mechanism 35 to clamp the mold die M and also causes the lower heater 36 to heat the lower die LM so that the powder resin R in the lower-die cavity MC is melted and cured. The compression-molding module 3, in other words, causes the mold clamp mechanism 35 to clamp the mold die M with a resin-sealing target substrate Sa and a release film F between the upper die UM and the lower die LM. This allows the resin-sealing target substrate Sa to be sealed up in resin. The above operations allow, for example, chips mounted on a resin-sealing target substrate Sa (substrate to be molded) to be sealed up in resin in the lower-die cavity MC, thereby producing a resin-sealed substrate Sb (resin-molded product).

### First Embodiment

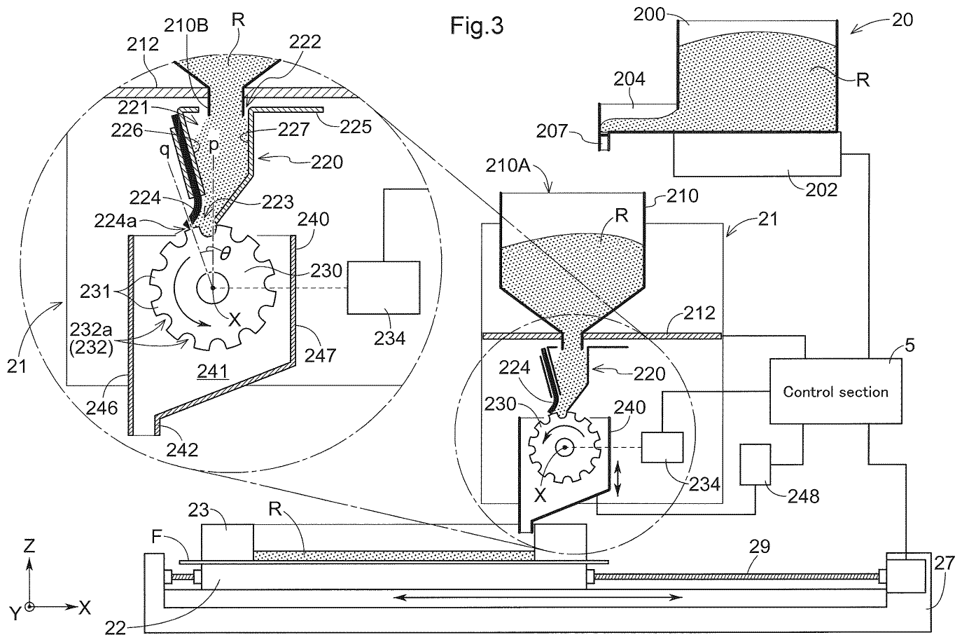

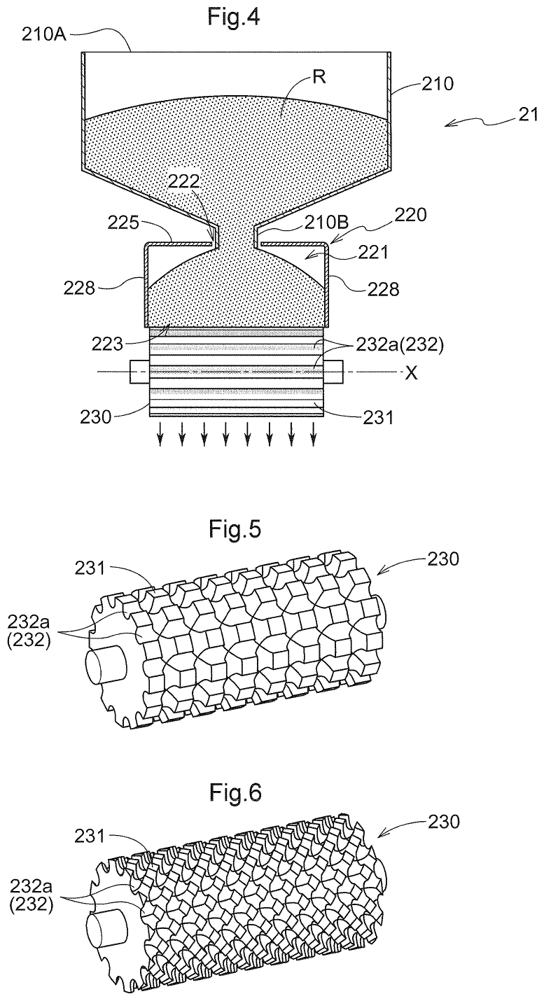

The description below deals with a resin supply mechanism 21 for a first embodiment. FIGS. 3 and 4 are diagrams schematically illustrating the resin conveyor mechanism 20, the resin supply mechanism 21, and the X-Y table of the resin supply module 2.

The resin conveyor mechanism 20, as illustrated in FIG. 3, includes a resin storage 200, a vibration section 202, a resin conveyor path 204, and a first resin drop opening 207. The resin storage 200 is configured to store powder resin R. The resin conveyor path 204 includes a first end (one end) connected to the resin storage 200 at a portion near its bottom and a second end (the other end) provided with the first resin drop opening 207, which serves to supply powder resin R into a resin reservoir 210 of the resin supply mechanism 21. The vibration section 202 is configured to vibrate the resin storage 200 and the resin conveyor path 204 in accordance with an instruction from the control section 5. Vibrating the resin storage 200 and the resin conveyor path 204 with use of the vibration section 202 causes powder resin R in the resin storage 200 to flow through the resin conveyor path 204 and drop from the first resin drop opening 207 (which has a rectangular cross section) into the resin reservoir 210 of the resin supply mechanism 21. During this operation, the vibration section 202 vibrates the resin storage 200 and the resin conveyor path 204.

The resin supply mechanism 21 includes a resin reservoir 210, a weighing section 212, a resin supply section 220, a rotor 230, a rotor drive section 234, a guide 240, and a guide drive section 248.

The resin reservoir 210 is configured to temporarily store powder resin R supplied from the resin storage 200 through the resin conveyor path 204 and supply the powder resin R to the resin supply section 220 (described later). The resin reservoir 210 has a first resin receiving opening 210A at an upper portion thereof and a second resin drop opening 210B at a lower portion thereof. The resin storage 200 lets powder resin R therein drop freely from the first resin drop opening 207 to be supplied through the first resin receiving opening 210A into the resin reservoir 210. The resin reservoir 210 is vertically below the first resin drop opening 207. The resin reservoir 210 temporarily stores the powder resin R and then lets the powder resin R drop freely from the second resin drop opening 210B into the resin supply section 220. The present embodiment is configured such that the first resin receiving opening 210A and the second resin drop opening 210B each have a circular cross section and that the second resin drop opening 210B has an inner diameter smaller than that of the first resin receiving opening 210A.

The second resin drop opening 210B is provided with a shutter (not illustrated in the drawings) in the form of a choke/throttle valve. The shutter is configured to block the second resin drop opening 210B to prevent powder resin R from dropping from the resin reservoir 210 and keep powder resin R in the resin reservoir 210. Closing the shutter prevents powder resin R from dropping into the resin supply section 220 so that the resin reservoir 210 is removable from the resin supply mechanism 21 for replacement of the powder resin R with another kind for molding use while the resin reservoir 210 keeps the powder resin R therein.

The resin reservoir 210 for the present embodiment has no function of vibrating itself, and lets powder resin R from the resin conveyor mechanism 20 flow toward the second resin drop opening 210B by its self weight. The resin reservoir 210 may alternatively be provided with a separate vibration mechanism configured to vibrate the resin reservoir 210 to cause powder resin R on the inner surface of the resin reservoir 210 to drop.

The weighing section 212 is configured to weigh the resin reservoir 210 to determine the weight of powder resin R therein, and transmits data on the weight of the powder resin R to the control section 5.

The resin supply section 220 is configured to supply powder resin R from the resin reservoir 210 onto the rotor 230. The resin supply section 220 is vertically below the second resin drop opening 210B and in the form of a hollow box with a hollow space 221 to receive powder resin R. The resin supply section 220 for the present embodiment includes an upper plate 225, a front plate 226, a back plate 227, and two side plates 228 (see FIG. 4). As illustrated in FIG. 3, the resin supply section 220 includes no bottom plate, and has at a bottom portion thereof a rectangular third resin drop opening 223 (which is an example of the “opening”) defined by the front plate 226, the back plate 227, and the side plates 228. The upper plate 225 has a second resin receiving opening 222 having a circular cross section and configured to introduce powder resin R from the second resin drop opening 210B into the space 221. The resin supply section 220 thus receives powder resin R through the second resin receiving opening 222 and discharges powder resin R through the third resin drop opening 223. As illustrated in FIG. 3, the second resin drop opening 210B for the present embodiment has a leading end in the second resin receiving opening 222.

The resin supply section 220 for the present embodiment is configured as follows: The back plate 227 includes a vertical upper-half portion, and is bent toward the front plate 226 at an intermediate portion to include a lower-half portion inclined relative to the vertical direction. The front plate 226 is in the form of a flat plate as a whole, and is inclined relative to the vertical direction such that a portion further below is closer to the back plate 227. The third resin drop opening 223 is in the shape of a rectangle with the internal dimension between the side plates 228 larger than the internal dimension between the front plate 226 and the back plate 227.

The front plate 226 has a lower end provided with a plate-shaped scraper 224 (which is an example of the “spatula-shaped member”) made of an elastic material such as a rubber or an elastomer and protruding downward from the front plate 226. The resin supply section 220 is positioned such that the scraper 224 has a first end (lower end) in contact with the outer surface 231 (side surface) of the rotor 230 and that the back plate 227 is separated from the outer surface 231 by a small gap.

The rotor 230 is in the shape of a circular column, and has depressions 232 on the outer surface 231. The depressions 232 for the present embodiment are, as an example, grooves 232a each extending along the rotation axis X of the rotor 230 (which is an example of the “axis”; hereinafter also referred to simply as “axis X”) and having a length equal to the length of the rotor 230 along the axis X (hereinafter also referred to as “total length” of the rotor 230) (see FIG. 4). The rotor drive section 234 is, for example, a motor configured to rotate the rotor 230 about the axis X. The rotor 230 may be made of any material such as resin, ceramic, or metal, and is desirably made of ceramic to prevent generation of a foreign substance.

The rotor 230 is configured to receive resin from the third resin drop opening 223 of the resin supply section 220. The rotor 230 is vertically below the third resin drop opening 223. The rotor 230, specifically, has a total length equal to or slightly smaller than the internal dimension between the side plates 228 of the resin supply section 220. The rotor 230 is at a position corresponding to a position between the side plates 228 (see FIG. 4). The back plate 227 has a lower end vertically above the axis X of the rotor 230 or on the side of the rotation direction relative to the axis X. The scraper 224 is in contact with the outer surface 231 of the rotor 230 at a contact portion 224a further on the side of the rotation direction than the back plate 227. In other words, the rotor 230 rotates in a direction from the back plate 227 toward the scraper 224 (or the front plate 226). The third resin drop opening 223 is, as viewed vertically, entirely offset in the direction of the rotation of the rotor 230 relative to the axis X. The contact portion 224a, at which the scraper 224 is in contact with the outer surface 231 of the rotor 230, is a linear portion.

The scraper 224 is oriented such that a vertical plane p and a contact plane q form an angle θ of not smaller than 0 degrees and not larger than 45 degrees, preferably not larger than 30 degrees, the vertical plane p extending vertically through the axis X, the contact plane q extending through the axis X and the contact portion 224a. The rotor 230 is, as described above, so close to the third resin drop opening 223 as to have an outer surface 231 only barely separated from the third resin drop opening 223. The resin supply section 220 introduces powder resin R from the resin reservoir 210 into the space 221 and lets the powder resin R spread in the space 221 entirely along the axis X before dropping through the third resin drop opening 223. This allows powder resin R to be supplied into the grooves 232a of the rotor 230 entirely in the lengthwise direction.

While the rotor 230 is rotating, an entire groove 232a receives powder resin R in response to facing the third resin drop opening 223, that is, in response to being vertically above the axis X. At this stage, the powder resin R not only fills the entire groove 232a but also heaps up above the outer surface 231 (that is, radially outward). Then, in response to the groove 232a reaching the contact portion 224a of the scraper 224 as a result of rotation of the rotor 230, the scraper 224 levels off the heap of powder resin R over the groove 232a as an excess. After passing through the contact portion 224a, the groove 232a holds powder resin R in a volume equal to the capacity of the groove 232a. In response to the groove 232a being below the axis X as a result of further rotation of the rotor 230, the groove 232a lets the powder resin R drop freely. This configuration ensures that the rotor 230 lets powder resin R drop in a fixed amount from each groove 232a. The rotor 230 is not vibrated to let powder resin R drop therefrom.

The guide 240 is configured to receive powder resin R from the grooves 232a and let the powder resin R drop through a fourth resin drop opening 242 onto a release film F. The guide 240 is in the form of an angular barrel housing in an internal space 241 thereof at least a portion of the rotor 230 which portion is below the axis X. FIG. 3 illustrates the rotor 230 as being almost entirely housed in the internal space 241. The guide 240 for the present embodiment includes a front plate 246 (which is an example of the “plate”), a back plate 247, and two side plates (not illustrated in the drawings). The resin supply mechanism 21 has a fourth resin drop opening 242 defined by the front plate 246, the back plate 247, and the side plates and in the shape of a rectangle with the internal dimension between the side plates larger than the internal dimension between the front plate 246 and the back plate 247. The fourth resin drop opening 242 has a dimension along the axis X (that is, the internal dimension between the side plates) which dimension is equal to or slightly larger than the total length of the rotor 230.

The guide 240 is configured such that the back plate 247 includes a vertical upper-half portion, and is bent toward the front plate 246 at an intermediate portion and also bent at a portion near the lower end to extend vertically, that is, to include a lower-half portion inclined relative to the vertical direction except for the portion near the lower end. The front plate 226 is in the form of a vertical flat plate as a whole.

The guide drive section 248 is, for example, an air cylinder configured to move the guide 240 vertically upward and downward. The rotor 230 and the resin supply section 220 are not configured to move upward and downward together with the guide 240.

The resin supply mechanism 21 for the present embodiment, as described above, includes a rotor 230 with a large total length along the axis X, as compared to a conventional configuration of supplying powder resin R from a resin material supply opening onto a release film F. This allows the resin supply mechanism 21 to supply onto a release film F powder resin R in a volume equal to the capacity of a groove 232a at a time. This in turn allows the resin supply mechanism 21 to supply powder resin R in a large amount per unit time, as compared to conventional resin supply mechanisms. The above configuration allows the resin supply mechanism 21 for the present embodiment to supply powder resin R while a release film F is moved only once in only one direction for a substrate so large that conventional art would, for instance, be required to reciprocate a release film F several times to supply powder resin R. The above configuration thereby remarkably reduces the time period necessary to supply powder resin R onto a release film F.

The scraper 224 levels off an excessive heap of powder resin R over each groove 232a as the rotor 230 rotates. This ensures that after passing through the scraper 224, the groove 232a holds powder resin R in a volume equal to its capacity. Continuously rotating the rotor 230 allows powder resin R to be supplied continuously in a volume equal to the capacity of each groove 232a. As described above, the resin supply mechanism 21 for the present embodiment supplies powder resin R onto a release film F with continued accuracy, in a large amount per unit time, and within a reduced time period.

### [Method for Producing a Resin Molded Product]

The description below deals with a method for producing a resin molded product, with reference to FIGS. 1 to 3.

The description below deals with how the resin molding apparatus D operates to seal up a substrate S (that is, a resin-sealing target substrate Sa) in resin, with reference to FIG. 1. The control section 5 controls the operations described below. First, at the substrate supply/container module 4, the substrate placement section 41 receives a resin-sealing target substrate Sa from the first container section 43. Next, the substrate loader 42 moves in the −Y direction from the predetermined position S1 to receive the resin-sealing target substrate Sa from the substrate placement section 41. The check mechanism then checks in which area chips and/or the like are disposed on the substrate S (resin-sealing target substrate Sa) as an object to be molded. The control section 5 has calculated (or set) in advance, for example, an intended amount of supply of powder resin R, an intended position of supply of powder resin R, and/or a resin supply path in the resin supply area inward of a frame 23 on the basis of at least, for example, the size of the substrate S as an object to be molded and/or the area in which chips and/or the like are disposed. The substrate loader 42 returns to the predetermined position S1. Next, the substrate loader 42 moves in the +X direction to, for example, a predetermined position P1 in the compression-molding module 3B. Next, at the compression-molding module 3B, the substrate loader 42 moves in the −Y direction and stops at a predetermined position C1 over the lower die LM. Next, the substrate loader 42 moves upward to fix the resin-sealing target substrate Sa onto the upper die UM. The substrate loader 42 then returns to the predetermined position S1 at the substrate supply/container module 4.

Next, at the resin supply module 2, the release film supply mechanism 25 supplies a release film F onto the resin scattering table 22. A portion with a predetermined size is cut off from the release film F. Next, the resin loader 26 moves in the −Y direction from the predetermined position M1 and receives a frame 23 as cleaned by the cleaning mechanism 24. Next, the resin loader 26 moves further in the −Y direction and places the frame 23 onto the release film F as suctioned on the resin scattering table 22. The resin loader 26 then returns to the position M1. Next, the resin scattering table 22 moves in the +X direction and stops with the frame 23 at a predetermined position below the resin supply mechanism 21. Next, the resin scattering table 22 (with the frame 23 thereon) moves in the X and Y directions while the resin supply mechanism 21 supplies powder resin R in a predetermined amount onto the release film F inward of the frame 23 (resin supply step). The resin scattering table 22 then returns to its original position.

The resin supply step involves the resin supply mechanism 21 supplying onto the release film F powder resin R with a weight corresponding to the intended supply amount under control of the control section 5 as illustrated in FIG. 3. First, the vibration of the vibration section 202 of the resin conveyor mechanism 20 causes powder resin R to be conveyed from the resin storage 200 through the resin conveyor path 204 and supplied through the first resin drop opening 207 into the resin reservoir 210 of the resin supply mechanism 21. During this operation, the resin reservoir 210 keeps the shutter (not illustrated in the drawings) closed. Then, in response to the weighing section 212 determining that the resin reservoir 210 stores a predetermined amount of resin and transmitting data on the weight to the control section 5, the control section 5 stops the vibration section 202 to stop the resin conveyor mechanism 20 from supplying powder resin R and opens the shutter to let powder resin R drop from the second resin drop opening 210B into the resin supply section 220.

In response to the weighing section 212 determining on the basis of the amount of reduction of powder resin R that the resin supply section 220 has received a predetermined amount of powder resin R, the guide drive section 248 moves the guide 240 downward to position the fourth resin drop opening 242 below the upper surface (top surface) of the frame 23 (that is, close to the release film F) as illustrated in FIG. 3. Then, the control section 5 activates the rotor drive section 234 to cause the rotor 230 to start rotating. When the rotor 230 starts rotating, powder resin R not only fills an entire first groove 232a in the outer surface 231 of the rotor 230, but also heaps up above the outer surface 231 (that is, radially outward).

As the first groove 232a moves past the contact portion 224a of the scraper 224 as a result of rotation of the rotor 230, the scraper 224 levels off the heap of powder resin R above the outer surface 231 as an excess. After moving past the contact portion 224a, the first groove 232a holds powder resin R in a volume equal to the capacity of the first groove 232a. The resin supply section 220 then supplies powder resin R including the powder resin R that the scraper 224 has leveled off into a second groove 232a backward relative to the direction of the rotation of the rotor 230. In response to the first groove 232a, which has moved past the contact portion 224a, being below the axis X as a result of further rotation of the rotor 230, the first groove 232a lets the powder resin R therein drop freely toward the guide 240.

The guide 240 receives the powder resin R from the first groove 232a and lets the powder resin R drop from the fourth resin drop opening 242 onto a release film F. During this operation, the control section 5 causes the resin scattering table 22 of the X-Y table to move along the preset resin supply path to receive powder resin R at the intended supply position in the intended supply amount. The control section 5 calculates an intended amount of supply of powder resin R, an intended position of supply of powder resin R, and a resin supply path for powder resin R on the basis of the following information that the control section 5 stores: (i) the size of the substrate S as an object to be molded and/or the area in which chips and/or the like are disposed on the substrate S, (ii) the amount of reduction of powder resin R in the resin reservoir 210 per unit time, (iii) the number of revolutions of the rotor 230, and (iv) a calculation table or formula for the amount of powder resin R supplied onto a release film F per unit time which amount is based on the capacity of each groove 232a.

In response to the guide 240 finishing supplying powder resin R onto the release film F, the guide 240 moves upward to position the fourth resin drop opening 242 above the upper surface of the frame 23. Next, the resin loader 26 moves in the −Y direction from the predetermined position M1 to receive the release film F (which has received powder resin R) from the resin scattering table 22, and returns to the position M1 (see FIG. 1). Next, the resin loader 26 moves in the −X direction to the predetermined position P1 at the compression-molding module 3B. Next, at the compression-molding module 3B, the resin loader 26 moves in the −Y direction to the predetermined position C1 above the lower die LM. Next, the resin loader 26 moves downward and transfers the release film F (which has received powder resin R) into the lower-die cavity MC. The resin loader 26 then returns to the predetermined position M1.

Next, at the compression-molding module 3B, the mold clamp mechanism 35 moves the lower die LM upward to claim the upper die UM and the lower die LM as illustrated in FIG. 2. After a predetermined time period, the mold clamp mechanism 35 moves the lower die LM downward to open the upper die UM and the lower die LM (molding step). Next, the substrate loader 42 moves from the predetermined position S1 at the substrate supply/container module 4 to the predetermined position C1 above the lower die LM to receive the resin-sealed substrate Sb. Next, the substrate loader 42 moves past the predetermined position S1 to a position above the substrate placement section 41 to transfer the resin-sealed substrate Sb to the substrate placement section 41. The substrate placement section 41 transfers the resin-sealed substrate Sb into the second container section 44. This completes the resin sealing process. The control section 5 determines whether to continue supplying powder resin R onto a release film F. If the control section 5 selects to continue the supply, the control section 5 repeats the above operations. If the control section 5 selects not to continue the supply, the control section 5 ends its control.

### [Variation of Depressions in Rotor]

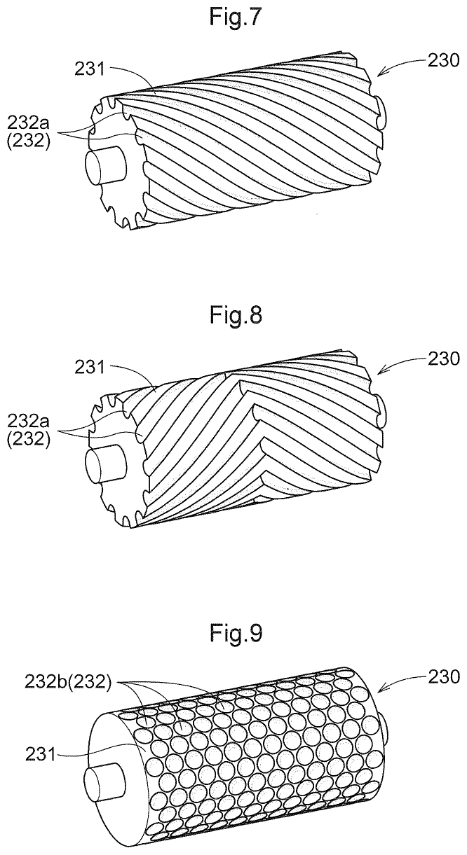

The embodiment described above is configured such that the rotor 230 has grooves 232a extending along the axis X as the depressions 232 in the outer surface 231. This disclosure is, however, not limited to such a configuration. The rotor 230 may, for instance, have grooves 232a in a grid pattern along the axis X and in the direction perpendicular thereto as illustrated in FIG. 5. The grooves 232a in a grid pattern may alternatively extend in directions inclined relative to the axis X as illustrated in FIG. 6. The rotor 230 may have grooves 232a inclined relative to the axis X and extending in a helical pattern as illustrated in FIG. 7. The grooves 232a in a helical pattern may alternatively extend in two directions as illustrated in FIG. 8. The rotor 230 may have dimples 232b instead of grooves 232a as the depressions 232 as illustrated in FIG. 9. The depressions 232 may, as described above, have any shape in accordance with the amount and accuracy of supply of powder resin R. With the rotor 230 having dimples 232b as the depressions 232, adjacent dimples 232b are apart from each other by a distance smaller than the distance by which adjacent grooves 232a are apart from each other. This allows the rotor 230 to drop powder resin R more continuously as it rotates and thereby supply powder resin R onto a release film F more accurately.

### [Variation of Shape of Scraper]

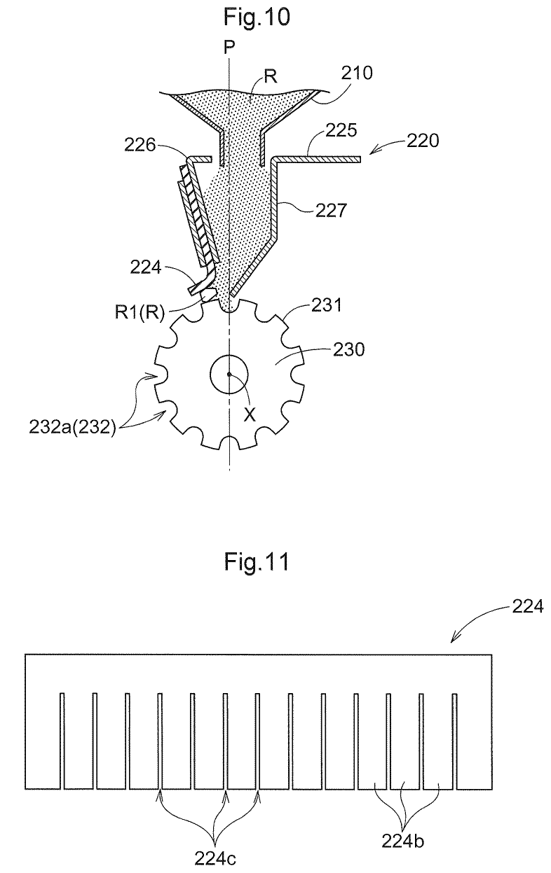

The scraper 224 for the present embodiment is in the form of a flat plate. If powder resin R contains a coarse particle R1 with a particle size larger than normal for a reason, the coarse particle R1 may be caught between the scraper 224 and the outer surface 231 of the rotor 230 as illustrated in FIG. 10. Such a coarse particle R1 may lift the scraper 224 and let powder resin R (which has normal particle sizes smaller than that of the coarse particle R1) flow past the scraper 224 on the lateral sides of the coarse particle R1. This may result in the disadvantage of a release film F receiving powder resin R in an amount larger than the intended supply amount.

The scraper 224 may, to inhibit the above disadvantage, include two or more scraping sections 224b separated from one another by slits 224c extending from a first end of the scraper 224 to a second end thereof over a predetermined length as illustrated in FIG. 11. The scraper 224 is, in this case, in the form of a shop curtain. The first end of the scraper 224 refers to that end of the scraper 224 which is in contact with the outer surface 231 of the rotor 230. With the scraper 224 including two or more scraping sections 224b separated by slits 224c, a coarse particle R1 contained in powder resin R and caught between the scraper 224 and the outer surface 231 will lift only that scraping section 224b which is in contact with the coarse particle R1, and will not lift the other scraping sections 224b, so that the other scraping sections 224b remain in contact with the contact portion 224a. This configuration prevents or minimizes the flow of normally sized powder resin R past the scraper 224 on the lateral sides of a coarse particle R1, and thereby inhibits the disadvantage of a release film F receiving powder resin R in an amount larger than the intended supply amount.

### Second Embodiment

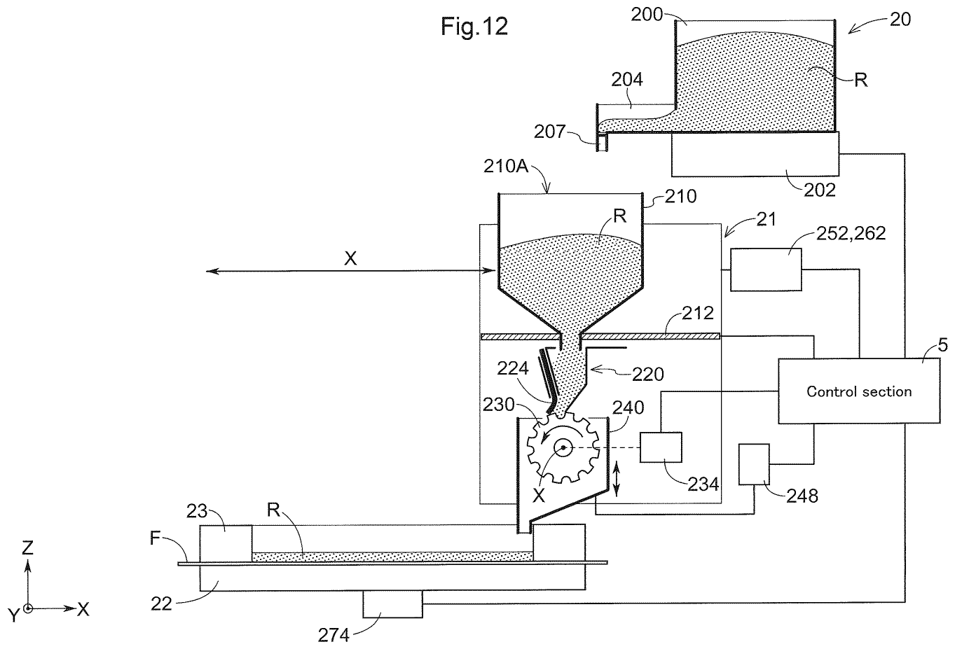

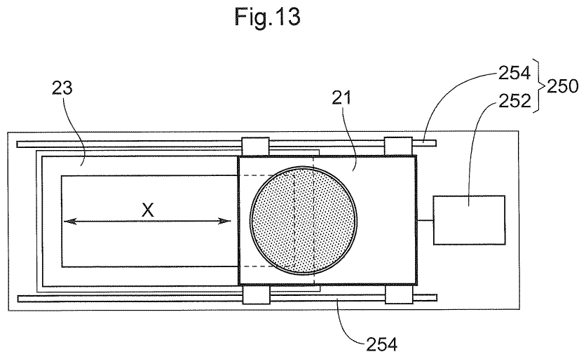

The description below deals with a resin supply mechanism 21 for a second embodiment with reference to FIGS. 12 and 13. The resin supply mechanism 21 for the present embodiment is provided with a first moving mechanism 250 (which is an example of the “moving mechanism”) configured to move the entire resin supply mechanism 21 in the X direction. The resin supply module 2 for the present embodiment includes a resin scattering table 22 (which is an example of the “table”) but not a base 27 or a ball screw 29. The resin scattering table 22 is not configured to move in the X or Y direction. The present embodiment is otherwise identical in configuration to the first embodiment, and such an identical configuration is not detailed here.

The first moving mechanism 250 includes a first drive section 252 and a pair of first rails 254 extending in the X direction and supporting the resin supply mechanism 21. The first drive section 252 is, for example, a motor. The resin supply mechanism 21 is configured to move on the first rails 254 in the +X and −X directions with use of the first drive section 252.

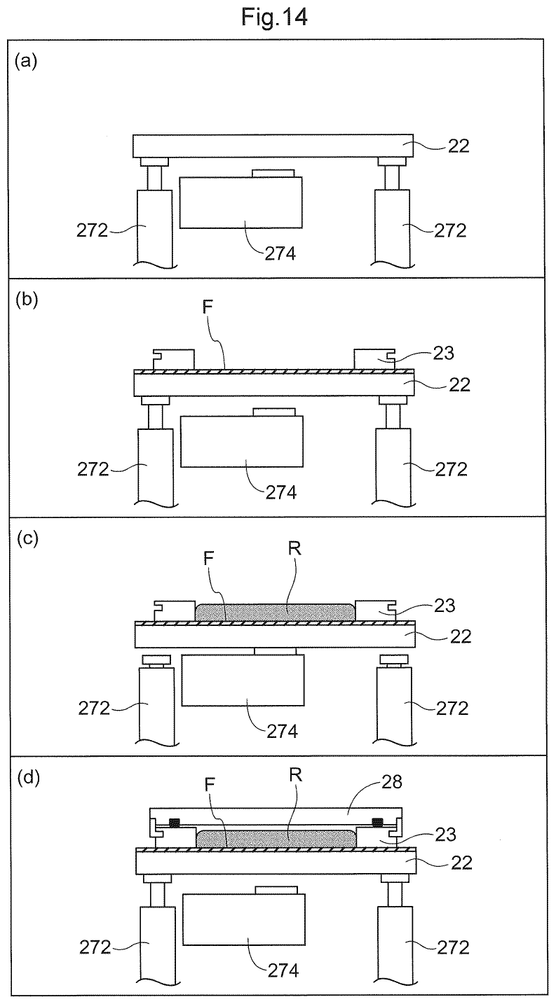

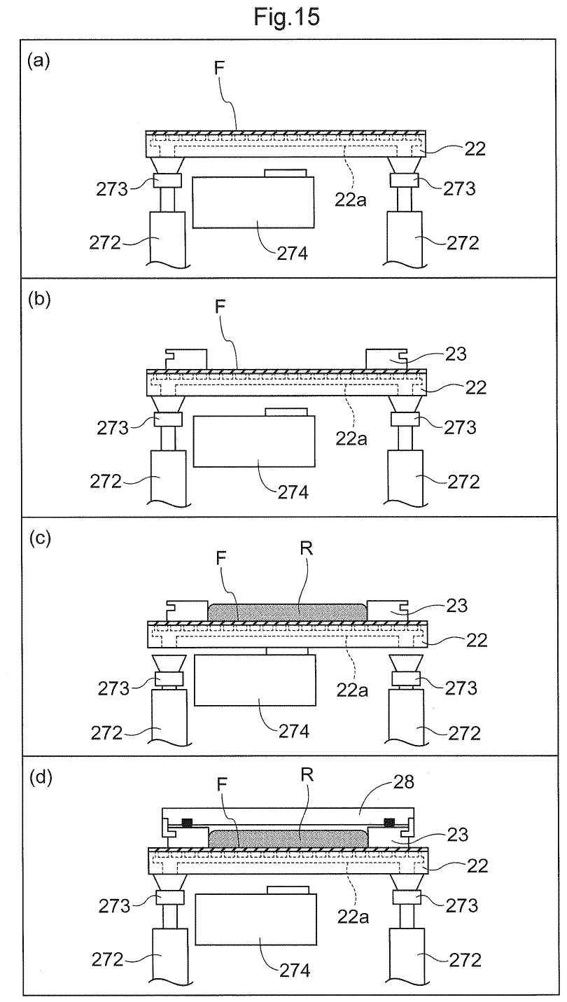

The present embodiment, which includes a resin scattering table 22 not configured to move in the X or Y direction as described above, includes a weighing mechanism 270 configured to weigh powder resin R on a release film F on the resin scattering table 22. The description below deals in detail with how the weighing mechanism 270 weighs powder resin R, with reference to FIGS. 14 and 15.

The weighing mechanism 270 includes four rods 272 and a measurer 274 (which is an example of the “measuring section”) configured to weigh powder resin R. The resin scattering table 22 is supported by the four rods 272 (two of which are not illustrated in the drawings) as illustrated in (a) of FIG. 14. The measurer 274 is under the resin scattering table 22 and apart therefrom by a gap.

Next, the resin scattering table 22 receives a release film F and a frame 23 thereon as illustrated in (b) of FIG. 14. The release film F simply lies on the resin scattering table 22, and is not suctioned thereon with use of air. The measurer 274 remains apart from the resin scattering table 22 by a gap at this stage to avoid being affected by an impact transmitted as a result of placing the frame 23 onto the resin scattering table 22.

Next, the rods 272 lower their respective leading ends to bring the lower surface of the resin scattering table 22 into contact with the measurer 274 to allow the measurer 274 to measure the total weigh of the resin scattering table 22, the frame 23, and the release film F. The measurer 274 transmits data on the weight to the control section 5 for use as a reference weight before supply of powder resin R. Then, the resin supply mechanism 21 supplies powder resin R onto the release film F while moving in the X direction as illustrated in (c) of FIG. 14. During this operation, the measurer 274 determines an additional weight as the weight of the powder resin R that the resin supply mechanism 21 has supplied on the release film F. The control section 5 determines whether the weight of the powder resin R is equal to the intended supply amount.

Then, the rods 272 raise their respective leading ends to separate the resin scattering table 22 from the measurer 274 as illustrated in (d) of FIG. 14. After that, a transfer section 28 firmly holds the frame 23 and the release film F and transfers the frame 23 and the release film F to the resin loader 26.

The description below deals with how the weighing mechanism 270 weighs powder resin R with use of a resin scattering table 22 configured to suction a release film F by sucking air, with reference to FIG. 15.

The resin scattering table 22, as illustrated in (a) of FIG. 15 with a broken line, includes a suction path 22a for sucking air to suction a release film F. The four rods 272 each have a leading end provided with a suction section 273 supporting the resin scattering table 22, connected to the suction path 22a, and configured to suck air with use of a suction source (not illustrated in the drawings) such as a microejector or a vacuum pump. The measurer 274 is under the resin scattering table 22 and apart therefrom by a gap. At this stage, the suction source is off and does not suck air.

Next, as illustrated in (b) of FIG. 15, the resin scattering table 22 receives a release film F and a frame 23. The weighing mechanism 270 turns on the suction source for the release film F to be suctioned on the resin scattering table 22 by air suction. The measurer 274 remains apart from the resin scattering table 22 by a gap at this stage

Next, the weighing mechanism 270 turns off the suction source to stop air suction. The rods 272, in this state, each lower the suction section 273 at its leading end to bring the lower surface of the resin scattering table 22 into contact with the measurer 274. The measurer 274 transmits data on the weight to the control section 5 for use as a reference weight before supply of powder resin R. Then, the resin supply mechanism 21 supplies powder resin R onto the release film F while moving in the X direction as illustrated in (c) of FIG. 15. During this operation, the measurer 274 determines an additional weight as the weight of the powder resin R that the resin supply mechanism 21 has supplied on the release film F. The control section 5 determines whether the weight of the powder resin R is equal to the intended supply amount.

Then, the rods 272 raise their respective leading ends to separate the resin scattering table 22 from the measurer 274 as illustrated in (d) of FIG. 15. After that, a transfer section 28 firmly holds the frame 23 and the release film F and transfers the frame 23 and the release film F to the resin loader 26.

The resin supply mechanism 21 supplies powder resin R onto a release film F while moving with the resin scattering table 22 fixed in position as described above. This allows the measurer 274 to directly weigh the powder resin R that the resin supply mechanism 21 has supplied on the release film F. This in turn allows the present embodiment to weigh powder resin R on a release film F more accurately than in the case of weighing powder resin R on a release film F indirectly on the basis of the weight of the resin reservoir 210.

### Third Embodiment

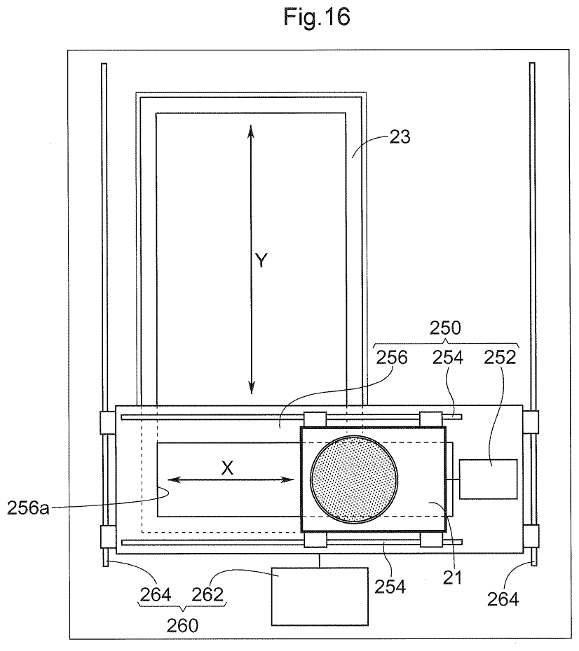

The description below deals with a resin supply mechanism 21 for a third embodiment with reference to FIGS. 12 and 16. The resin supply mechanism 21 for the present embodiment is provided with a first moving mechanism 250 and a second moving mechanism 260. The first moving mechanism 250 (which is an example of the “moving mechanism”) is configured to move the entire resin supply mechanism 21 in the X direction relative to a release film F and a frame 23 each as an object to be supplied (see FIG. 12). The second moving mechanism 260 (which is an example of the “moving mechanism”) is configured to move the entire resin supply mechanism 21 in the Y direction relative to a release film F and a frame 23 each as an object to be supplied (see FIG. 16). The first moving mechanism 250 for the embodiment illustrated in FIG. 16 includes a base 256 supporting the resin supply mechanism 21 and having an opening 256a to move the resin supply mechanism 21 in the X direction and supply powder resin R onto a release film F. The present embodiment is otherwise identical in configuration to the second embodiment, and such an identical configuration is not detailed here.

The second moving mechanism 260 includes a second drive section 262 and a pair of second rails 264 extending in the Y direction and supporting the resin supply mechanism 21 with the base 256 in-between. The second drive section 262 is, for example, a motor. The resin supply mechanism 21 is configured to move on the second rails 264 in the +Y and −Y directions with use of the second drive section 262.

The present embodiment is configured to move the resin supply mechanism 21 in both the X and Y directions. This allows the resin supply mechanism 21 to supply powder resin R onto a release film F without moving the resin scattering table 22 even in the case where the resin scattering table 22 is compatible with a large substrate S. Further, the present embodiment is not configured to move the resin scattering table 22 while the resin supply mechanism 21 is supplying powder resin R. This allows the weighing mechanism 270 to weigh powder resin R on a release film F more accurately.

### Fourth Embodiment

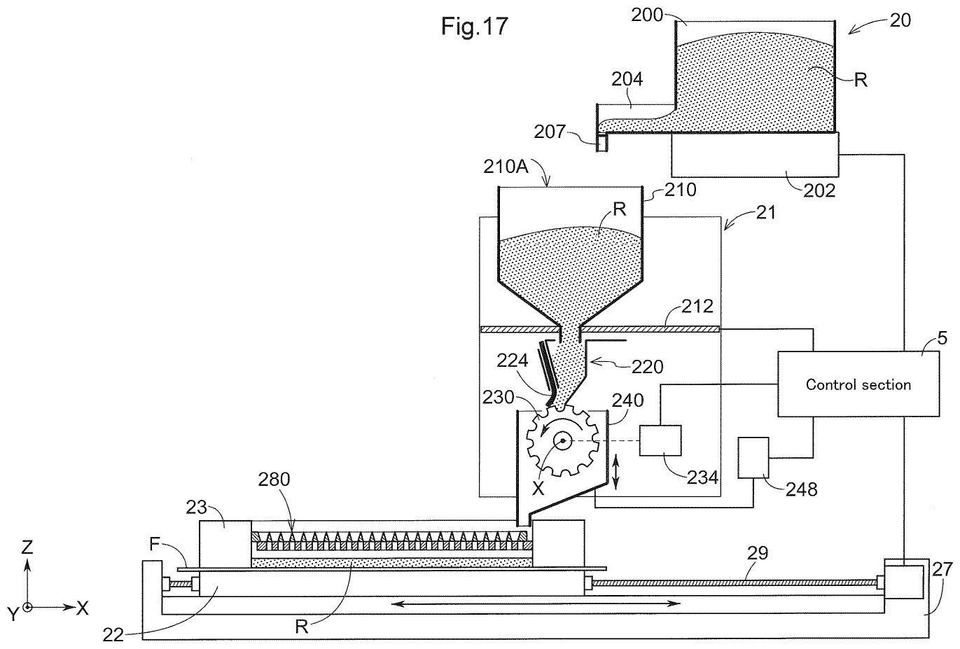

The present embodiment is identical to the first embodiment in terms of how the resin supply mechanism 21 is configured, and is also identical thereto in the configuration of placing a release film F and a frame 23 onto the resin scattering table 22 on the base 27 of the X-Y table. The resin supply mechanism 21 for the present embodiment is not configured to supply powder resin R directly onto a release film F: The present embodiment, as illustrated in FIG. 17, includes a resin holding mechanism 280 (which is an example of the “object to be supplied”) configured to temporarily hold powder resin R from the resin supply mechanism 21 and supply the powder resin R onto a release film F. The present embodiment is suitable for, for example, an apparatus configured to supply resin onto a release film F in a mold die. The present embodiment is otherwise identical in configuration to the first embodiment, and such an identical configuration is not detailed here.

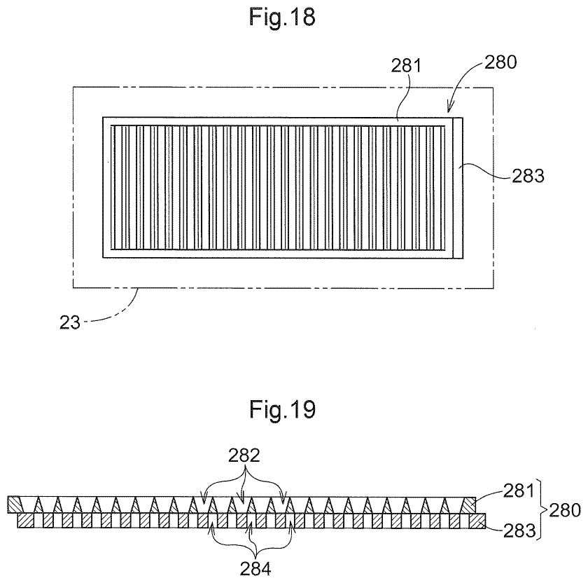

The resin holding mechanism 280, as illustrated in FIGS. 18 and 19, includes a holder 281 and a shutter 283. The holder 281 has two or more first slits 282. The shutter 283 is below and in close contact with the holder 282, and has two or more second slits 284 parallel to the first slits 282. FIGS. 17 to 19 illustrate the first slits 282 and the second slits 284 in respective numbers larger or smaller than actual.

The resin holding mechanism 280 for the present embodiment has total dimensions substantially equal to the internal dimensions of the frame 23, and is inward of the frame 23 and above the release film F. The holder 281 is above the shutter 283. The first slits 282 each have a width (that is, the dimension in the direction in which the first slits 282 are arranged) that is larger further above and smaller further below. This allows the first slits 282 to easily receive powder resin R from the resin supply mechanism 21, which is above the resin holding mechanism 280. The second slits 284 each have a width (that is, the dimension in the direction in which the second slits 284 are arranged) that is equal above and below. The first slits 282 each have a downward width equal to or larger than the width of each second slit 284. The first slits 282 have a pitch (that is, the distance between adjacent first slits 282) equal to that of the second slits 284 (that is, the distance between adjacent second slits 284). With this configuration, shifting the shutter 283 relative to the holder 281 widthwise by half the pitch connects or disconnects the second slits 284 to or from the first slits 282. FIGS. 17 to 19 each illustrate a resin holding mechanism 280 with the second slits 284 disconnected from the first slits 282.

The present embodiment is configured as follows: The resin supply mechanism 21 supplies powder resin R to the resin holding mechanism 280 while moving the resin scattering table 22 of the X-Y table with the first slits 282 disconnected from the second slits 284. The first slits 282 receive the powder resin R and, as they are disconnected from the second slits 284, hold the powder resin R. In response to all the first slits 282 being filled with powder resin R equally and uniformly, the rotor 230 stops rotating to stop the supply of powder resin R. For this operation, the resin holding mechanism 280 may be vibrated for all the first slits 282 to be filled with powder resin R equally and uniformly.

Next, the shutter 283 is moved widthwise by half the pitch by a shutter moving mechanism (not illustrated in the drawings) to connect the first slits 282 to the second slits 284. This allows the powder resin R in the first slits 282 to be supplied through the second slits 284 onto the release film F.

Including the resin holding mechanism 280 between the resin supply mechanism 21 and the resin scattering table 22 as described above allows powder resin R to be supplied onto a release film F in a mold die. Reciprocating the resin holding mechanism 280 two or more times allows the supply of powder resin R even in the case where the substrate S is large.

### Alternative Embodiments

The description below deals with embodiments alternative to the embodiments described above. For ease of understanding, the description below uses the same terms and reference signs as in the description of the above embodiments for similar elements.

<1> The embodiments described above are each configured such that the first resin drop opening 207, the first resin receiving opening 210A, the second resin drop opening 210B, and the second resin receiving opening 222 each have a circular cross section. This disclosure is, however, not limited to such a configuration. The above openings may each have any cross-sectional shape such as rectangular, and may have respective cross-sectional shapes different from one another.

The resin molding apparatus D should, however, preferably be configured such that the second resin drop opening 210B and the second resin receiving opening 222 share the same rectangular shape with the third resin drop opening 223 and each have a length equal to the total length of the rotor 230. This allows the resin supply mechanism 21 to use a smaller amount of powder resin R to fill each entire groove 232a in the rotor 230 with powder resin R.

<2> The embodiments described above are each configured such that the back plate 227 of the resin supply section 220 includes a vertical upper-half portion, and is bent toward the front plate 226 at an intermediate portion and that the front plate 226 is in the form of a flat plate as a whole, and is inclined relative to the vertical direction such that a portion further below is closer to the back plate 227. The front plate 226 and the back plate 227 are, however, not limited to the above in shape, and may each have any shape as long as the third resin drop opening 223 is so shaped as to be capable of appropriately supplying powder resin R onto the rotor 230.

<3> The embodiments described above are each configured such that the back plate 247 of the guide 240 includes a vertical upper-half portion, and is bent toward the front plate 246 at an intermediate portion and that the front plate 246 is in the form of a flat plate as a whole, and is oriented vertically. The front plate 246 and the back plate 247 are, however, not limited to the above in shape, and may each have any shape as long as the fourth resin drop opening 242 is so shaped as to be capable of appropriately supplying powder resin R onto a release film F.

<4> The embodiments described above are each configured such that either the resin supply mechanism 21 or the resin scattering table 22 is movable, but may each be altered such that both the resin supply mechanism 21 and the resin scattering table 22 are moveable.

<5> The substrate S for each embodiment described above may have any shape such as circular or rectangular, and may also have any size. Appropriately designing the respective amounts of movement of the resin scattering table 22, the first moving mechanism 250, and/or the second moving mechanism 260 allows the resin molding apparatus D to be compatible with a substrate S of any shape and size.

<6> The embodiments described above are based on the die-down compression method, but may alternatively be based on the die-up compression method, where an object to be molded such as a substrate is an object to be supplied onto which the resin supply mechanism 21 supplies powder resin R.

<7> The embodiments described above each involve a release film F, a frame 23 and the resin holding mechanism 280 each as an object to be supplied, but may alternatively each involve a substrate S and/or the mold die M each as an object to be supplied.

### SUMMARY OF ABOVE EMBODIMENTS

The description below summarizes the resin molding apparatus D and the method for producing a resin molded product (that is, a resin-sealed substrate Sb) each described above as an embodiment.

(1) The resin molding apparatus D characteristically includes: a resin supply mechanism 21 configured to supply powder resin R onto at least one object to be supplied (that is, a frame 23, a release film F, a resin holding mechanism 280); a mold die M including: an upper die UM; and a lower die LM facing the upper die UM, the mold die M being configured to receive the powder resin R between the upper die UM and the lower die LM; and a mold clamp mechanism 35 configured to clamp the mold die M for compression molding, the resin supply mechanism 21 including: a rotor 230 in a shape of a circular column with an outer surface 231 having a plurality of depressions 232 (that is, grooves 232a, dimples 232b), the rotor 230 being configured to rotate about an axis X; a resin supply section 220 configured to store the powder resin R and having an opening (that is, a third resin drop opening 223) for letting the powder resin R drop freely onto the rotor 230; and a spatula-shaped member (that is, a scraper 224) having a first end in contact with the outer surface 231 of the rotor 230.

Improving the productivity of the compression-molding modules 3 in producing resin-sealed substrates Sb requires the resin supply mechanism 21 of the resin supply module 2 to supply powder resin R onto an object to be supplied (that is, a release film F) rapidly and accurately. The resin supply mechanism disclosed in Patent Literature 1 includes a resin material supply opening that allows only a small amount of powder resin R to be supplied onto an object to be supplied per unit time to improve the supply accuracy. This means that the resin supply mechanism requires a long time to supply powder resin R onto the entire object to be supplied and requires a longer time for a larger object to be supplied. In view of that, the resin supply mechanism 21 for the present embodiment includes a rotor 230 with a large total length, as compared to the conventional resin material supply opening. This allows the resin supply mechanism 21 to supply onto a release film F powder resin R in a volume equal to the capacity of a groove 232a at a time. This in turn allows the resin supply mechanism 21 to supply powder resin R in a large amount per unit time, as compared to conventional resin supply mechanisms. During this operation, the scraper 224 levels off an excessive heap of powder resin R over each groove 232a. This allows powder resin R to be supplied continuously in a volume equal to the capacity of each groove 232a. As described above, the resin supply mechanism 21 supplies powder resin R onto a release film F with continued accuracy, in a large amount per unit time, and within a reduced time period.

(2) The resin molding apparatus D described in item (1) above may be further configured such that the opening (that is, the third resin drop opening 223) of the resin supply section 220 is, as viewed vertically, offset in a direction of the rotation of the rotor 230 relative to the axis X.

The above configuration prevents powder resin R from dropping from the third resin drop opening 223 into a groove 232a on the side opposite to the rotation direction relative to the axis X. This allows powder resin R to be supplied onto a release film F in a volume equal to the capacity of each groove 232a.

(3) The resin molding apparatus D described in item (2) above may be further configured such that a vertical plane p and a contact plane q form an angle θ of not larger than 45 degrees, the vertical plane p extending vertically through the axis X, the contact plane q extending through the axis X and a portion (that is, a contact portion 224a) of the spatula-shaped member (that is, the scraper 224) which portion is in contact with the outer surface 231.

The above configuration prevents powder resin R from dropping onto a release film F by its self weight through a gap formed by a coarse particle R1 in the powder resin R lifting the scraper 224. This minimizes the disadvantage of a release film F receiving powder resin R in an amount larger than the intended supply amount.

(4) The resin molding apparatus D described in any one of items (1) to (3) above may be further configured such that the at least one object to be supplied includes: a release film F; and a frame (that is, a frame 23).

The above configuration allows the resin supply mechanism 21 to supply powder resin R accurately inward of the frame 23 on the release film F.

(5) The resin molding apparatus D described in any one of items (1) to (4) above may be further configured such that the spatula-shaped member (that is, the scraper 224) has a slit 224c extending from the first end toward a second end of the spatula-shaped member.

With the above configuration, the scraper 224 includes two or more scraping sections 224b separated by slits 224c. A coarse particle R1 contained in powder resin R and caught between the scraper 224 and the outer surface 231 of the rotor 230 will lift only that scraping section 224b which is in contact with the coarse particle R1, and will not lift the other scraping sections 224b. This configuration prevents or minimizes the flow of powder resin R past the scraper 224 on the lateral sides of a coarse particle R1, and thereby inhibits the disadvantage of a release film F receiving powder resin R in an amount larger than the intended supply amount.

(6) The resin molding apparatus D described in any one of items (1) to (5) above may further include: a plate (that is, a front plate 246) parallel to the axis X and facing a side of the rotor 230 relative to the axis X on which side the outer surface 231 moves downward as the rotor 230 rotates.

With the above configuration, if the rotation of the rotor 230 throws powder resin R out of a groove 232a forward in the rotation direction by centrifugal force, the powder resin R will collide with the front plate 246 and drop downward. This allows the resin supply mechanism 21 to supply powder resin R at the intended supply position in the intended supply amount.

(7) The resin molding apparatus D described in item (6) above may be further configured such that the plate (that is, the front plate 246) is movable upward and downward.

With the above configuration, moving the guide 240, which includes the front plate 246, downward to bring the guide 240 closer to a release film F allows powder resin R to be supplied more accurately at the intended supply position in the intended supply amount.

(8) The resin molding apparatus D described in any one of items (1) to (7) above may further include: a moving mechanism (that is, a first moving mechanism 250, a second moving mechanism 260) configured to move the resin supply mechanism 21.

The above configuration allows powder resin R to be supplied while the table (that is, the resin scattering table 22) on which a release film F is placed is fixed. This, for instance, allows a measurer 274 for weighing powder resin R to be positioned under the resin scattering table 22.

(9) The resin molding apparatus D described in item (8) above may further include: a table (that is, a resin scattering table 22) configured to receive the at least one object to be supplied (that is, the frame 23, the release film F); and a measuring section (that is, a measurer 274) disposed below the table (that is, the resin scattering table 22) and configured to weigh the powder resin R on the at least one object to be supplied (that is, the frame 23, the release film F).

The above configuration allows the measurer 274 to weigh powder resin R on a release film F directly and thus more accurately.

(10) A method for producing a resin molded product (that is, a resin-sealed substrate Sb) with use of the resin molding apparatus D according to any one of (1) to (9) above includes: supplying the powder resin R onto the at least one object to be supplied (that is, the frame 23, the release film F, the resin holding mechanism 280) with use of the resin supply mechanism 21; and supplying a substrate to be molded (that is a resin-sealing target substrate Sa) and the at least one object to be supplied (that is, the release film F) onto the mold die M and clamping the mold die M with use of the mold clamp mechanism 35 for the compression molding.

The above method includes a resin supply step in which the resin supply mechanism 21 includes a rotor 230 with a large total length, as compared to the conventional resin material supply opening, and thereby supplies onto a release film F powder resin R in a volume equal to the capacity of a groove 232a at a time. This allows the resin supply mechanism 21 to supply powder resin R onto an object to be supplied (that is, a frame 23, a release film F) in a large amount per unit time, as compared to conventional resin supply mechanisms. During this operation, the scraper 224 levels off an excessive heap of powder resin R over each groove 232a. This allows powder resin R to be supplied continuously in a volume equal to the capacity of each groove 232a. The method for producing a resin molded product (that is, a resin-sealed substrate Sb), as described above, allows the resin supply mechanism 21 to supply powder resin R onto a release film F with continued accuracy in a large amount per unit time.

### INDUSTRIAL APPLICABILITY

This disclosure is applicable to a resin molding apparatus and a method for producing a resin molded product.

### REFERENCE SIGNS LIST

21 Resin supply mechanism
22 Resin scattering table (table)
23 Frame (object to be supplied)
35 Mold clamp mechanism
220 Resin supply section
223 Third resin drop opening (opening)
224 Scraper (spatula-shaped member)
224a Contact portion
224c Slit
230 Rotor
231 Outer surface
232 Depression
232a Groove (depression)
232b Dimple (depression)
246 Front plate (plate)
250 First moving mechanism (moving mechanism)
260 Second moving mechanism (moving mechanism)
274 Measurer (measuring section)
280 Resin holding mechanism (object to be supplied)
F Release film (object to be supplied)
LM Lower die
M Mold die
p Vertical plane
q Contact plane
R Powder resin
Sa Resin-sealing target substrate (substrate to be molded)
Sb Resin-sealed substrate (resin molded product)
UM Upper die
X Axis

1. A resin molding apparatus, comprising:
a resin supply mechanism configured to supply powder resin onto at least one object to be supplied;
a mold die including:
an upper die; and
a lower die facing the upper die,
the mold die being configured to receive the powder resin between the upper die and the lower die; and
a mold clamp mechanism configured to clamp the mold die for compression molding,
the resin supply mechanism including:
a rotor in a shape of a circular column with an outer surface having a plurality of depressions, the rotor being configured to rotate about an axis;
a resin supply section configured to store the powder resin and having an opening for letting the powder resin drop freely onto the rotor; and
a spatula-shaped member having a first end in contact with the outer surface of the rotor.

2. The resin molding apparatus according to claim 1, wherein
the opening of the resin supply section is, as viewed vertically, offset in a direction of the rotation of the rotor relative to the axis.

3. The resin molding apparatus according to claim 2, wherein
a vertical plane and a contact plane form an angle of not larger than 45 degrees, the vertical plane extending vertically through the axis, the contact plane extending through the axis and a portion of the spatula-shaped member which portion is in contact with the outer surface.

4. The resin molding apparatus according to claim 1, wherein
the at least one object to be supplied includes:
a release film; and
a frame.

5. The resin molding apparatus according to claim 1, wherein
the spatula-shaped member has a slit extending from the first end toward a second end of the spatula-shaped member.

6. The resin molding apparatus according to claim 1, further comprising:
a plate parallel to the axis and facing a side of the rotor relative to the axis on which side the outer surface moves downward as the rotor rotates.

7. The resin molding apparatus according to claim 6, wherein
the plate is movable upward and downward.

8. The resin molding apparatus according to claim 1, further comprising:
a moving mechanism configured to move the resin supply mechanism.

9. The resin molding apparatus according to claim 8, further comprising:
a table configured to receive the at least one object to be supplied; and
a measuring section disposed below the table and configured to weigh the powder resin on the at least one object to be supplied.

10. A method for producing a resin molded product with use of a resin molding apparatus according to claim 1,
the method comprising:
supplying the powder resin onto the at least one object to be supplied with use of the resin supply mechanism; and
supplying a substrate to be molded and the at least one object to be supplied onto the mold die and clamping the mold die with use of the mold clamp mechanism for the compression molding.
